(19) United States
(12) Patent Application Publication
(10) Pub. No.: US 2015/0033231 A1
(43) Pub. Date: Jan. 29, 2015

(54) ELECTRONIC DEVICE AND METHOD FOR CONTROLLING THE ELECTRONIC DEVICE VIA FINGERPRINT RECOGNITION

(71) Applicant: Ye Xin Technology Consulting Co., Ltd., Hsinchu (TW)

(72) Inventor: I-Wei WU, Hsinchu (TW)

(73) Assignee: Ye Xin Technology Consulting Co., Ltd., Hsinchu (TW)

(21) Appl. No.: 13/956,395

(22) Filed: Aug. 1, 2013

(30) Foreign Application Priority Data
Jul. 24, 2013 (TW) 102126569

(51) Int. Cl. G06K 9/00; G06F 9/445

(52) U.S. Cl. CPC G06K 9/00087; G06F 9/445
USPC 718/100

(57) ABSTRACT

An electronic device includes a fingerprint sensor used for controlling the electronic device to perform predetermined functions. A plurality of reference fingerprints and a plurality of functions corresponding to the reference fingerprints are set, where each reference fingerprint corresponds to a function. When a fingerprint matches one of the reference fingerprints is input upon the condition that the electronic device is in the locked state, the electronic device performs a function corresponding to the reference fingerprint that matches the input fingerprint. A plurality of predetermined operation objects corresponding to the reference fingerprints are set, where each of the reference fingerprints corresponds to a respective predetermined operation object. When an input fingerprint matches one of the reference fingerprints is detected upon the condition that the electronic device has been unlocked, an operation object corresponding to the reference fingerprint that matches the input fingerprint is activated.

### BACKGROUND

1. Technical Field

Embodiments of the present disclosure relate generally to fingerprint recognition technologies, and particularly to an electronic device and a method for controlling the electronic device via fingerprint recognition.

2. Description of Related Art

Many electronic devices, such as smart phones and laptop computers, may apply fingerprint recognition technologies to increase data security. For example, an electronic device may use fingerprints as a means to unlock the electronic device, thereby protecting personal data stored in the electronic device. However, the fingerprints may have no other further functions beyond being used to increase data security of the electronic device. Therefore, there is room for improvement in the art.

### BRIEF DESCRIPTION OF THE DRAWINGS

FIG. 1 is a schematic diagram of an exemplary embodiment of an electronic device.

FIG. 2 is a schematic diagram illustrating one example of a touch panel and a fingerprint sensor of the electronic device of FIG. 1.

FIG. 3 is a schematic block diagram of the electronic device of FIG. 1 including a plurality of functional modules.

FIG. 4 is flowchart of one embodiment of a method for controlling the electronic device of FIG. 1 via fingerprint recognition.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”. The reference “a plurality of” means “at least two”.

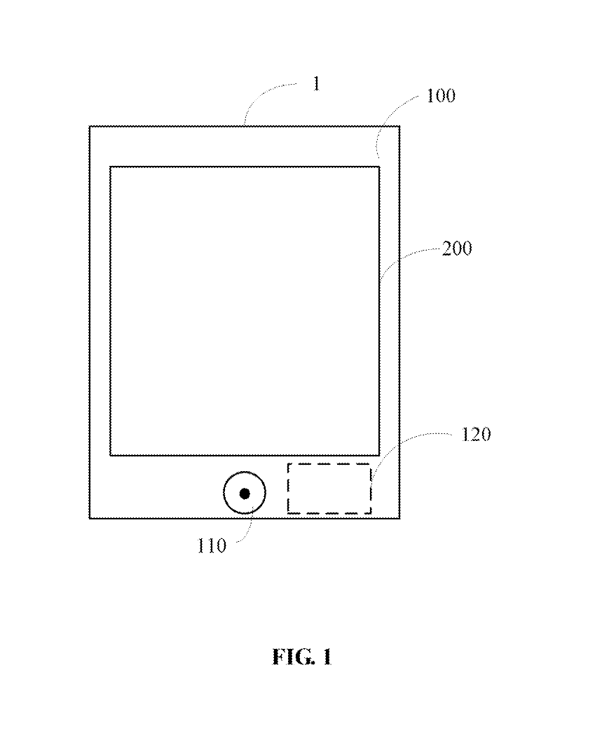

FIG. 1 is a schematic diagram of an exemplary embodiment of an electronic device 1. The electronic device 1 includes a frame area 100 and a display 200 surrounded by the frame area 100. A home screen button 110 and a fingerprint input area 120 near the screen button 110 are arranged in the frame area 100. In the embodiment, the electronic device 1 may be, for example, a smart phone, a personal digital assistant (PDA), or a laptop computer.

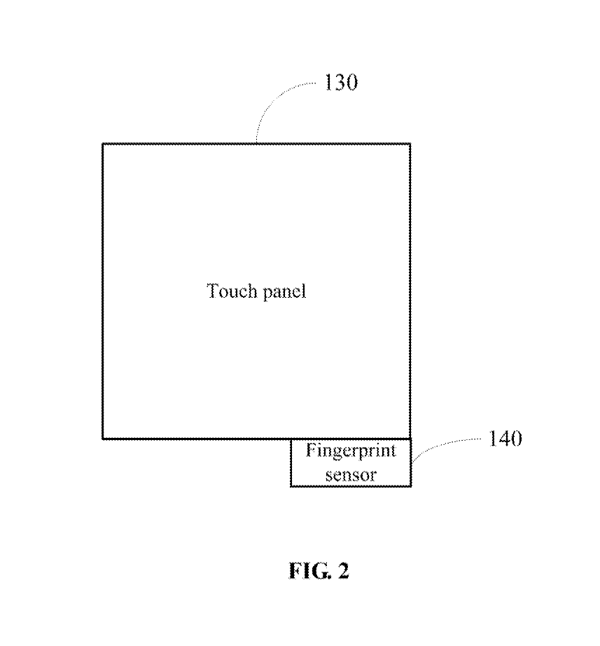

FIG. 2 shows that the electronic device 1 further includes a touch panel 130 and a fingerprint sensor 140. The touch panel 130 is arranged under or covers the display 200. The fingerprint sensor 140 is arranged under the fingerprint input area 120 and detects fingerprints input by a user from the fingerprint input area 120. In the embodiment, the display 200 may be a liquid crystal display (LCD) or an organic light emitting display (OLED). The fingerprint sensor 140 may be, for example, a conductive fingerprint sensor, an optical fingerprint sensor, an ultrasonic sensor, or a radio frequency (RF) sensor. In other embodiments, the fingerprint sensor 140 may be arranged under the display 200, and the fingerprint input area 120 may be displayed on the display 200 just over the fingerprint sensor 140.

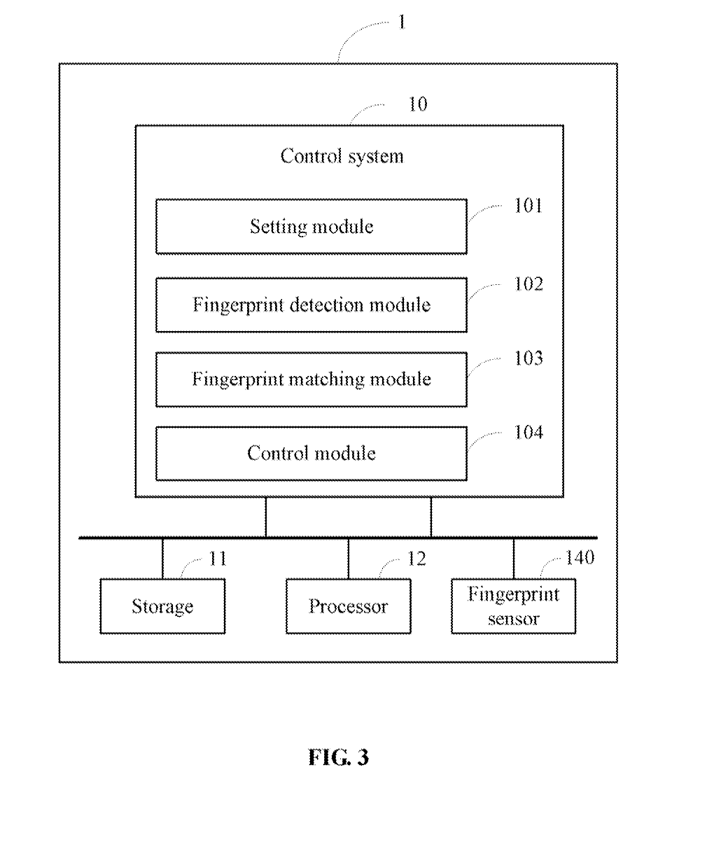

FIG. 3 is a schematic block diagram of the electronic device 1 of FIG. 1. In the embodiment, the electronic device 1 further includes a control system 10, a storage 11, and a processor 12. The control system 10 includes a setting module 101, a fingerprint detection module 102, a fingerprint matching module 103, and a control module 104. The modules 101-104 include computerized codes in the form of one or more programs that are stored in the storage 11 or other storage mediums of the electronic device 1. The computerized codes include computer-readable program codes (instructions) that are executed by the processor 12 to provide functions for the electronic device 1.

The storage 11 may be a cache or a dedicated memory, such as an erasable programmable read only memory (EPROM), a hard disk drive (HDD), or a flash memory. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

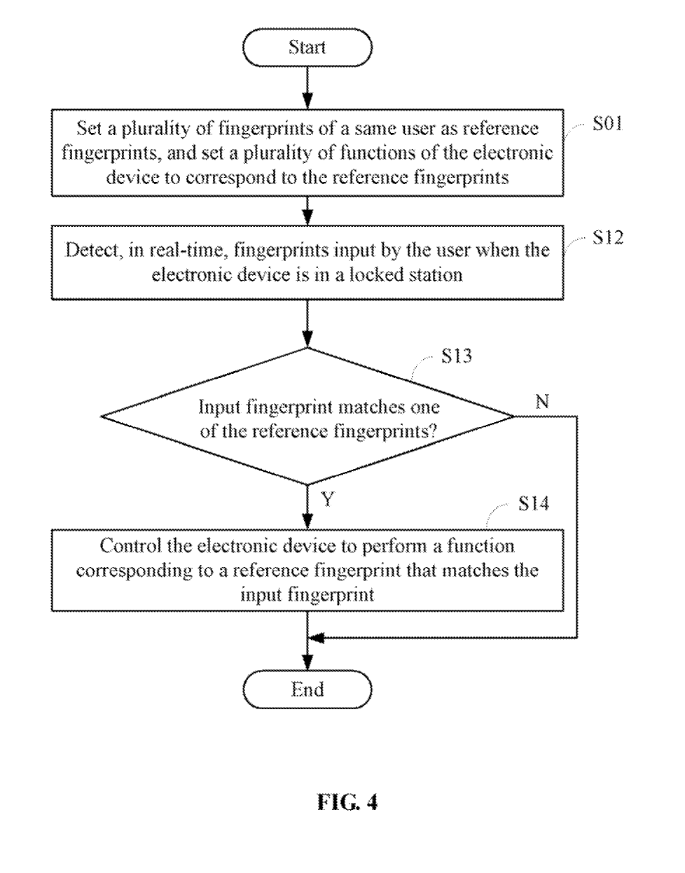

FIG. 4 is flowchart of one embodiment of a method for controlling the electronic device of FIG. 1 via fingerprint recognition. Depending on the embodiment, additional steps may be added, others removed, and the ordering of the steps may be changed.

In step S01 the setting module 101 sets a plurality of fingerprints of a same user of the electronic device as reference fingerprints, and sets a plurality of functions of the electronic device 1 to correspond to the reference fingerprints, where each function corresponds to one of the reference fingerprints. In one example, the setting module 101 may notify the user to input fingerprints of different fingers (e.g., thumb, forefinger, and little finger) from the fingerprint input area 120, and then obtains fingerprints input from the fingerprint input area 120 using the fingerprint sensor 140. The obtained fingerprints input by the user are defined as the reference fingerprints and are stored in the storage 11. In the embodiment, the reference fingerprints are input from an owner of the electronic device 1. Thus, the owner can use his/her own fingerprints to manage usage authorities of the electronic device 1 as described below. Therefore, fingerprints of other people (e.g., friends or families of the owner) who want to use the owner's electronic device 1 are not further needed.

In step S02, the fingerprint detection module 102 detects, in real-time, fingerprints input by the user from the fingerprint input area 120 using the fingerprint sensor 140 when the electronic device 1 is in a locked station.

In step S03, when a fingerprint is input by the user from the fingerprint input area 120, the fingerprint matching module 203 determines whether or not the input fingerprint matches one of the reference fingerprints. If the input fingerprint matches a reference fingerprint, the procedure goes to step S04. Otherwise, if the input fingerprint does not match any of the reference fingerprints, the procedure ends.

In step S04, the control module 104 controls the electronic device 1 to perform a function corresponding to the reference fingerprint that matches the input fingerprint.

In one embodiment, each of the set functions temporarily activates one or more predetermined operation objects of the electronic device 1. In the embodiment, the operation objects are defined to be various applications, texts, icons, files, or other items stored in the electronic device 1, which can be activated by the user to perform determined functions of the electronic device 1. In one embodiment, the operation objects include, for example, applications, files, documents, or other objects stored in the electronic device 1. In an example, the fingerprint of the thumb of the owner corresponds to a function of activating an “Internet” application which is frequently used by the owner or corresponds to a function of activating other particular application which is to be temporarily used by other people (e.g., a friend of the owner of the electronic device 1) under the locked state of the electronic device 1. Thus, the owner can authorize other people to temporarily use some of predetermined functions of the electronic device 1, which protects data security of the electronic device 1 when the electronic device 1 is used by other people.

In another embodiment, the set reference fingerprints can be used to activate predetermined operation objects of the electronic device 1 when the electronic device is working in an unlocked state. In one example, the setting module 101 further sets a plurality of predetermined operation objects of the electronic device 1 corresponding to the reference fingerprints, where each of the predetermined operation objects corresponds to one of the reference fingerprints. Then, when the electronic device 1 is working in an unlocked state, the fingerprint detection module 102 detects fingerprints input by the user. When the user inputs a fingerprint that matches a reference fingerprint upon the condition that the electronic device 1 is in the unlocked state, the control module 104 activates a predetermined operation object corresponding to the reference fingerprint that matches the input fingerprint. For example, when the electronic device 1 is in the unlocked state, the user may input a fingerprint of his/her forefinger to activate a “browser” application, and input a fingerprint of his/her thumb to activate a “camera” application. In other embodiments, the reference fingerprints are not only used to activate the operation objects, but also are used to display icons of the operation objects on the display 200, open the access of the operation objects to other people, or hide, delete, copy the operation objects, for example. In alternative embodiment, since the set reference fingerprints are used to activate some of predetermined operation objects of the electronic device 1 when the electronic device is working in an unlocked state, one or more of the reference fingerprints may be further defined as unlocking passwords of the electronic device 1.

Further, in other embodiments, each of the set functions controls the electronic device 1 to work at one of predetermined working modes, where each working mode corresponds to one of the reference fingerprints and one or more operation objects which are available when the electronic device 1 is working at the corresponding working mode. In this embodiment, the setting module 101 further sets one or more operation objects of the electronic device 1 to correspond to each of the working modes. When the user input a fingerprint matches a reference fingerprints under the condition that the electronic device 1 in the locked state, the control module 104 unlocks the electronic device 1 and control the electronic device 1 to work at a predetermined working mode corresponding to the reference fingerprint that matches the input fingerprint.

In an example, the working modes may include an administrator mode, a guest mode, and a children mode, and/or a sweetheart mode. The administrator mode may correspond to the fingerprint of the thumb of the user and all of operation objects of the electronic device 1 which are available when the electronic device 1 is working at the administrator mode. The guest mode may correspond to the fingerprint of the forefinger of the user and a first group of predetermined operation objects which are available when the electronic device 1 is working at the guest mode. The children mode may correspond to the fingerprint of the little finger of the user and a second group of predetermined operation objects which are available when the electronic device 1 is working at the children mode. The sweetheart mode may correspond to the fingerprint of the ring finger of the user and a third group of predetermined operation objects which are available when the electronic device 1 is working at the sweetheart mode.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a fingerprint sensor;
a processor; and
one or more programs executed by the at least one processor, to perform a method of:
setting a plurality of fingerprints of a same user of the electronic device as reference fingerprints, and setting a plurality of functions of the electronic device to correspond to the reference fingerprints, wherein each function corresponds to one of the reference fingerprints;
detecting, in real-time, fingerprints input by the user using the fingerprint sensor when the electronic device is in a locked state;
determining whether or not an input fingerprint matches one of the reference fingerprints when the input fingerprint is detected; and
controlling the electronic device to perform a function corresponding to a reference fingerprint, when the input fingerprint matches the reference fingerprint.

2. The electronic device according to claim 1, wherein each of the set functions temporarily activates one or more predetermined operation objects of the electronic device.

3. The electronic device according to claim 1, wherein each of the set functions controls the electronic device to work at one of predetermined working modes, wherein each working mode corresponds to one of the reference fingerprints and one or more operation objects which are available when the electronic device works at the corresponding working mode.

4. The electronic device according to claim 3, wherein the method further comprises:
setting one or more operation objects of the electronic device to correspond to each of the working mode; and
controlling the electronic device to work at a working mode corresponding the to the reference fingerprint that matches the input fingerprint.

5. The electronic device according to claim 3, wherein the working modes comprise an administrator mode, a guest mode, a children mode, and/or a sweetheart mode; the administrator mode corresponds all of operation objects of the electronic device which are available when the electronic device works at the administrator mode; the guest mode corresponds to a first group of predetermined operation objects which are available when the electronic device works at the guest mode; the children mode corresponds to a second group of predetermined operation objects which are available when the electronic device works at the children mode; the sweetheart mode corresponds to a third group of predetermined operation objects which are available when the electronic device works at the sweetheart mode.

6. The electronic device according to claim 1, wherein the method further comprises:
setting a plurality of predetermined operation objects of the electronic device corresponding to the reference fingerprints, where each of the predetermined operation objects corresponds to one of the reference fingerprints;
detecting fingerprints input by the user using the fingerprint sensor when the electronic device is in an unlocked state;
activating a predetermined operation object corresponding to a reference fingerprint when the user inputs a fingerprint that matches the reference fingerprint.

7. The electronic device according to claim 2, wherein the operation objects comprise applications, files, and documents stored in the electronic device.

8. The electronic device according to claim 1, wherein the setting step comprises:
notifying the user to input fingerprints of different fingers of the user;
obtaining fingerprints input by the user using the fingerprint sensor;
defining input fingerprints that are detected as the reference fingerprints; and
storing the reference fingerprints in a storage of the electronic device.

9. A computerized method for controlling an electronic device via fingerprint recognition, the electronic device comprising a fingerprint sensor, the method comprising:
setting a plurality of fingerprints of a same user of the electronic device as reference fingerprints, and setting a plurality of functions of the electronic device to correspond to the reference fingerprints, each function corresponding to one of the reference fingerprints;
detecting, in real-time, fingerprints input by the user using the fingerprint sensor when the electronic device is in a locked station;
determining whether or not an input fingerprint matches one of the reference fingerprints when the input fingerprint is detected; and
controlling the electronic device to perform a function corresponding to a reference fingerprint, when the input fingerprint matches the reference fingerprint.

10. The method according to claim 9, wherein each of the set functions is temporarily activating one or more predetermined operation objects of the electronic device.

11. The method according to claim 9, wherein each of the set functions controls the electronic device to work at one of predetermined working modes, each working mode corresponding to one of the reference fingerprints and one or more operation objects which are available when the electronic device works at the corresponding working mode.

12. The method according to claim 11, further comprising:
setting one or more operation objects of the electronic device to correspond to each of the working mode; and
controlling the electronic device to work at a working mode corresponding the to the reference fingerprint that matches the input fingerprint.

13. The method according to claim 11, wherein the working modes comprise an administrator mode, a guest mode, a children mode, and/or a sweetheart mode; the administrator mode corresponds all of operation objects of the electronic device which are available when the electronic device works at the administrator mode; the guest mode corresponds to a first group of predetermined operation objects which are available when the electronic device works at the guest mode; the children mode corresponds to a second group of predetermined operation objects which are available when the electronic device works at the children mode; the sweetheart mode corresponds to a third group of predetermined operation objects which are available when the electronic device works at the sweetheart mode.

14. The method according to claim 9, wherein the method further comprises:
setting a plurality of predetermined operation objects of the electronic device corresponding to the reference fingerprints, where each of the predetermined operation objects corresponds to one of the reference fingerprints;
detecting fingerprints input by the user using the fingerprint sensor when the electronic device is in an unlocked state;
activating a predetermined operation object corresponding to a reference fingerprint when the user input a fingerprint that matches the reference fingerprint.

15. The method according to claim 10, wherein the operation objects comprise applications, files, and documents stored in the electronic device.

16. The method according to claim 9, wherein the setting step comprises:
notifying the user to input fingerprints of different fingers;
obtaining fingerprints input by the user using the fingerprint sensor;
defining input fingerprints that are detected as the reference fingerprints; and
storing the reference fingerprints in a storage of the electronic device.

17. An electronic device, comprising:
a fingerprint sensor;
a processor; and
one or more programs executed by the at least one processor, to perform a method of:
setting a plurality of predetermined operation objects of the electronic device corresponding to a plurality of reference fingerprints, where each of the predetermined operation objects corresponds to one of the reference fingerprints;
detecting fingerprints input by the user using the fingerprint sensor when the electronic device is in an unlocked state;
activating a predetermined operation object corresponding to a reference fingerprint that matches the input fingerprint when the user input a fingerprint that matches the reference fingerprint.

18. The electronic device according to claims 17, wherein the operation objects comprise applications, files, and documents stored in the electronic device.
